(19) United States
(12) Patent Application Publication
(10) Pub. No.: US 2004/0194509 A1
(43) Pub. Date: Oct. 7, 2004

(54) Thin walled blown glassware ornaments manufacturing procedure

(76) Inventor: Robert Mostowski, Czestochowa (PL)

Correspondence Address: Josef Sofer, Sofer & Haroun, Suite 910, 317 Madison Avenue, New York, NY, 10017, US

(21) Appl. No.: 10/481,399

(22) PCT Filed: Oct. 29, 2001
(86) PCT No.: PCT/PL01/00084

(30) Foreign Application Priority Data
Jul. 18, 2001 (PL) P.348796

(51) Int. Cl. C03B 23/24

(52) U.S. Cl. 65/56; 65/46; 65/55; 65/58; 65/105

(57) ABSTRACT

The method of manufacturing thin-walled blown glass single layer ornaments with an open spatial body consists in obtaining a raw glass shell with a closed spatial body (10), which is opened by such operations like cutting through, cutting out or cutting off along division lines (12) by means of a mechanical saw, blowpipe or laser, and thus obtained open spatial bodies (14) undergo further treatment in order for the edges to be smoothed, to be joined with other details and for the surfaces to be decorated.

### RELATED APPLICATIONS

This application is a National Stage Application of PCT Patent Application PCT/PL01/00084, filed on Oct. 29, 2001, the entirety of which is incorporated herein by reference.

### FIELD OF THE INVENTION

The subject of the invention is the manufacturing procedure of thin-walled, single layer blown glassware ornaments of open solid three-dimensional body.

### BACKGROUND OF THE INVENTION

The glassware ornaments manufactured until now, for example the Christmas tree ornaments, are produced in form of a three-dimensional closed body and the simplest form is a sphere with a small protrusion and the extraction hole, used usually for suspension wire embedding and hooking the ornament. Other closed three-dimensional bodies blown up of glass heated to the plastic state and fit for the forming are the figures of: a person, a spruce, a ship and other bodies, every time three-dimensional and with a closed surface, which certainly limits the assortment of manufactured glassware ornaments made of thin walled blown glass and their decoration, except the silver plating of the internal surface took place only on their external surface.

The aim of the invention was to develop the method of blown-thin walled glassware manufacturing procedure in order to obtain a single layer thin glassware of the open spatial body bowl type, or the open basket and other similar bodies, therefore to obtain a wider assortment of single layer ornaments of open three dimensional bodies blown of thin-walled glass not manufactured until now without diminishing its durability and other utility values.

According to the invention, the ornaments made of thin-walled single layer blown glass with the open three-dimensional body are obtained in such manner, that the raw spatial glass shell of a certain shape is blown of a glass pipe heated to plastic state into the spatial mould, representing the final shape of the required figure and then the glass will be a bit less clear, but when the shell is blown without a mould, then the shell obtained will be fully clear. Depending on the further operations such glass shell obtained will be tempered and can be covered inside with a metal layer or just left as clear glass for further decoration.

The consecutive steps of blown glass shell preparation are: the shell cutting along one or more determined axes in case of getting two or more symmetrical details utilized in next operations. Another method consists in cutting out details when certain surfaces are cut out of the raw glass shell with a closed body along the determined lines obtained in the mould, or by means of a template or only according to the creator's vision, retaining, however, the original shape of the raw figure, for example an open basket. The method involves cutting out and rejecting the useless parts of the raw shell made of complete, closed body, leaving only part of the raw shell, for example an open form of a sleigh on blades.

The cutting activities are realized by means of such technical methods like mechanical saw, blowpipe or laser. The above activities can be applied jointly or alternately for a single shell treatment.

The single layer thin-walled blown ornament with the open body obtained by the above method in the consecutive step is treated in order to eliminate sharp edges after cutting and to decorate the exposed outer and internal surfaces.

The single layer thin-walled blown glass ornaments with the open body obtained in such manner can be used as the initial details for further connection with other open or closed body elements giving new possibilities of varied artistic combinations.

Another solution according to the invention is obtaining light, single layer details, for example such elements as the used so fardragonfly wings, having the shape of a closed bulb with the required curves, being, however, relatively heavy details of the whole ornament, in contrary to the present invention where the introduced method allows to obtain two or more elements from one full, closed spatial shell, after dividing it along previously determined cutting line, or by means of a template, lighter and providing a better visual image of the final ornament shape made exclusively of single layer open element or including such an element in its structure.

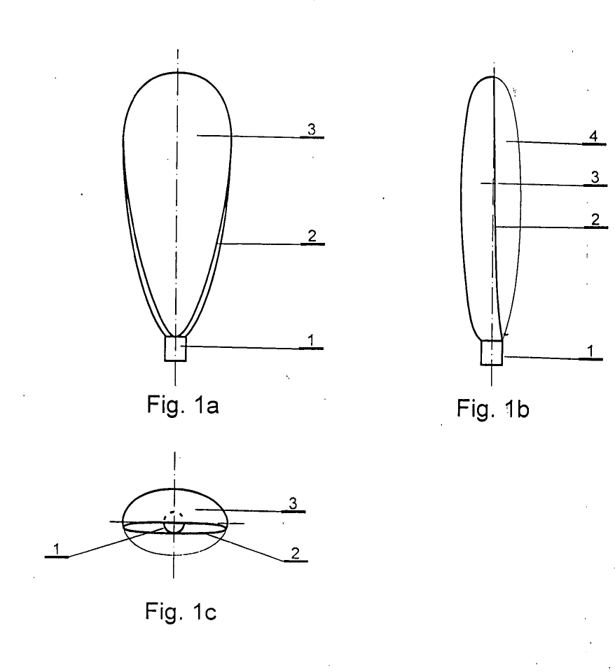

Some examples of the invention are presented in the drawings: In FIG. 1a to 1c a thin-walled blown glass shell of longitudinal shape is presented schematically in the front view after blowing up and cutting off its part (FIG. 1a), in the side view of the whole shell before cutting off (FIG. 1b) and the top view after the formation (FIG. 1c), which after cutting off along the marked lines forms a single layer open ornament detail;

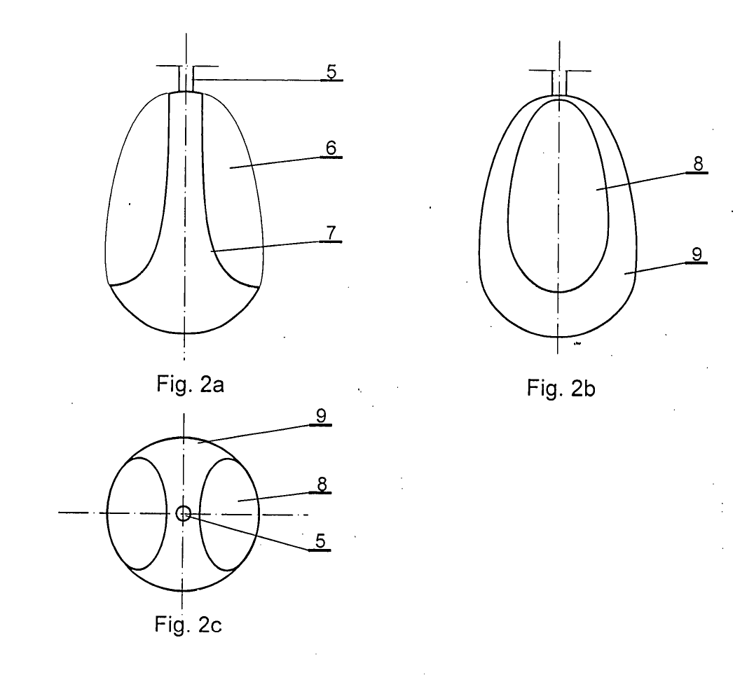

FIG. 2a to 2c present a thin-walled glass shell with the shape similar to the rotational ellipsoid with an extraction hole (FIG. 2a), with the symmetrically cut off surfaces on both sides of the body, opening the shell interior (FIG. 2b) and in the top view the formed shell in the shape of a basket (FIG. 2c) with the open interior.

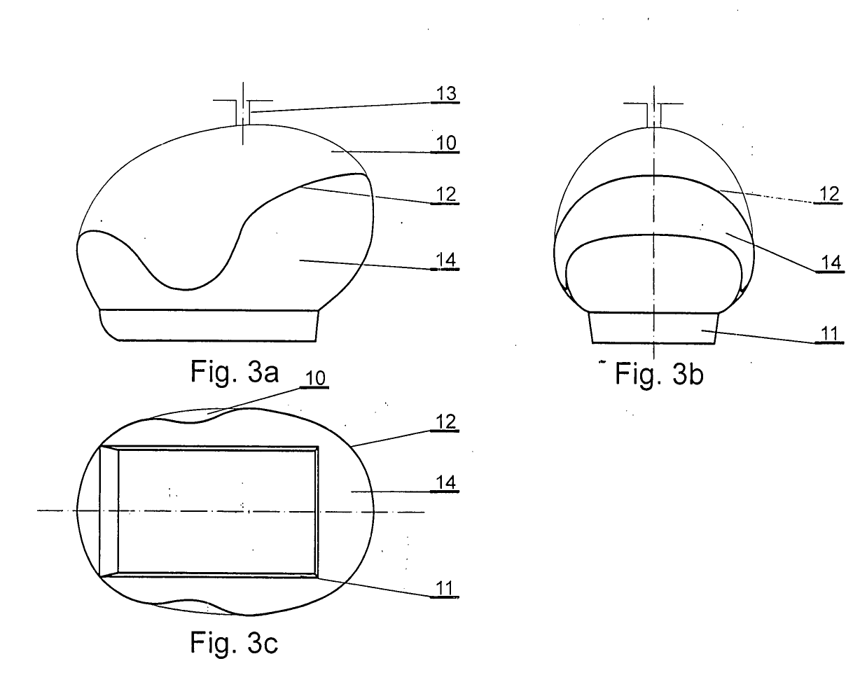

FIGS. 3a to 3c present a thin-walled glass shell with the shape similar to the elongated rotational ellipsoid somewhat inclined with an extraction hole on top and an additional flat base on the bottom down the longer body axis (FIG. 3a) with the marked line of cutting off the upper surface with the extraction hole (FIG. 3b) and the top view of the glass shell (FIG. 3c) after cutting off the upper shell part and exposing the interior of the figure.

In order to obtain a formed single layer element made of thin-walled blown glass many technical solutions are available, which will be presented in the examples of the execution.

### EXAMPLE I

In the execution example as in FIG. 1a to 1c a thin-walled shell of longitudinal shape is shown with an extraction hole 1 and marked cutting edge 2 along which the redundant part of a raw shell wall is separated 4 as result of which the final formed element is obtained 3 making up thedragonfly wing, and the extraction hole 1 left on the wing will be used for attaching the wing to the dragonfly trunk forming a light element of the final ornament.

### EXAMPLE II

In the execution example as in FIG. 2a to 2c a raw thin-walled full shell was obtained with the shape similar to the elongated rotational ellipsoid with an extraction hole 5 in the upper part of the raw shell 6 with cutting edges 7 marked on both sides forming symmetrical openings 8 exposing the interior of the raw shell and as result a basket 9 with the open interior was obtained consisting of a single layer of blown thin glass and an extraction tip 5 left is used to fix a wire hook.

### EXAMPLE III

In the execution example as in FIG. 3a to 3c a raw thin-walled full glass shell was obtained with the shape similar to the horizontally arranged, somewhat inclined rotational ellipsoid FIG. 10 with an oblate bottom base surface 11 and an extraction hood 13 in the upper part of the closed spatial body and with a marked curve 12 defining the cutting edge, along which the shell is cut, the upper part removed and thus a figure is obtained in form of a sleigh 14 on blades 11, open from the top, a side view of which is shown in FIG. 3b, whereas FIG. 3c shows the top view of the open body.

Such raw figures obtained from thin-walled blown glass with the open spatial body are later subjected to further treatment in order to remove sharp edges, particularly in case of mechanical cutting and are then decorated on both surfaces of the raw thin glass shell i.e. both the outer surface and the exposed internal surface.

Those simple open spatial body figures can be additionally supplemented with other figures and decorative details, like for example the open basket can be filled with loosely arranged fruits, likewise made of thin-walled blown glass, whereas a figure of a coachmen can be attached to the obtained figure of a sleigh on blades.

1. The method of manufacturing thin-walled blown glass ornaments characterized in that the raw blown glass shell of full, closed spatial body with an extraction hole is divided by mechanical, flame or laser cutting in order to obtain after the division a single layer, open spatial body according to the required pattern, intended for further operations like bonding, decoration and other.

2. The method of manufacturing thin-walled blown glass ornaments according to claim No. 1 characterized in that a raw blown glass shell is cut through along the marked lines or according to a templet, as result of which at least two symmetrical single layer elements are obtained.

3. The method of manufacturing thin-walled blown glass ornaments according to claim No. 1 characterized in that a raw blown glass shell 16/is subjected to a treatment by cutting out the marked surfaces 181 along the marked partition lines/71 or according to a templet, leaving the basic shellbody/9/with openings.

4. The method of manufacturing thin-walled blown glass ornaments according to claim No. 1 characterized in that a raw blown glass shell is subjected to a treatment by cutting off certain surfaces according to the pattern established/12/as a result of which only a part of the original shell body remains for further treatment/11, 14/.

5. The method of manufacturing thin-walled blown glass ornaments according to claim No. 1 characterized in that one raw blown glass shell can be subjected to different treatment methods by means of one or more partition techniques, i.e. mechanical cutting, gas blowpipe or laser cutting.

6. A method for manufacturing thin-walled blown glass ornaments, said method comprising the steps of:
dividing by any one of mechanical, flame or laser cutting, the raw blown glass shell of a full closed spatial body, said special body having an extraction hole;
obtaining an open spatial body after the cutting of a single layer, according to a pattern; and
bonding or decorating said open spatial body.

7. The method of manufacturing thin-walled blown glass ornaments according to claim 6, wherein said cutting of said raw blown glass shell of a full closed spatial body is performed either along marked lines or according to a template, resulting in at least two symmetrical single layer elements.

8. The method of manufacturing thin-walled blown glass ornaments according to claim 6, wherein said cutting of said raw blown glass shell of a full closed spatial body is performed by cutting out marked surfaces along either the marked partition lines or according to a template, resulting in a basic blown glass shell with openings.

9. The method of manufacturing thin-walled blown glass ornaments according to claim 6, wherein said cutting of said raw blown glass shell of a full closed spatial body is performed by cutting off certain surfaces according to a pattern, resulting in a part of said original blown glass shell remaining for further treatment.

10. The method of manufacturing thin-walled blown glass ornaments according to claim 6, wherein said step of cutting said raw blown glass shell of a full closed spatial body is performed using at least two cutting methods selected from the group of mechanical cutting, gas blowpipe and laser cutting techniques.
